(19) United States
(12) Patent Application Publication
(10) Pub. No.: US 2018/0160079 A1
(43) Pub. Date: Jun. 7, 2018

(54) PUPIL DETECTION DEVICE

(71) Applicant: PixArt Imaging Inc., Hsin-chu County (TW)

(72) Inventors: Yu-Hao HUANG, Hsin-chu (TW); Yi-Fang LEE, Hsin-chu (TW); Ming-Tsan KAO, Hsin-chu (TW); Meng-Huan HSIEH, Hsin-chu (TW); En-Feng HSU, Hsin-chu (TW); Nien-Tse CHEN, Hsin-chu (TW)

(21) Appl. No.: 15/886,013

(22) Filed: Feb. 1, 2018

Related U.S. Application Data
(63) Continuation of application No. 13/934,311, filed on Jul. 3, 2013.

(30) Foreign Application Priority Data
Jul. 20, 2012 (TW) 101126421

(51) Int. Cl. H04N 7/18; G06K 9/00; G02B 27/00; G06F 3/01

(52) U.S. Cl. CPC H04N 7/18; G06K 9/00597; G06F 3/013; G02B 27/0093

(57) ABSTRACT

A pupil detection device includes an active light source, an image sensor and a processing unit. The active light source emits light toward an eyeball. The image sensor captures at least one image frame of the eyeball to be served as an image to be identified. The processing unit is configured to calculate a minimum gray value in the image to be identified and to identify a plurality of pixels surrounding the minimum gray value and having gray values within a gray value range as a pupil area.

### CROSS REFERENCE TO RELATED APPLICATION

This application is a continuation application of U.S. patent application Ser. No. 13/934,311 filed on, Jul. 3, 2013, which claims the priority benefit of Taiwan Patent Application Serial Number 101126421, filed on Jul. 20, 2012, the full disclosure of which is incorporated herein by reference.

### BACKGROUND

### 1. Field of the Disclosure

This disclosure generally relates to an interactive system and, more particularly, to a pupil detection device.

### 2. Description of the Related Art

Interactive control mechanism can provide users a more instinctive control and thus it has been broadly applied to various multimedia systems, especially to an image display system having a display screen.

It is a general method to use a remote controller capable of capturing images as an interactive human machine interface, and the remote controller can be manufactured as various properties, such as a bat, a racket and a club. Another kind of human machine interface may be operated without using any handheld device. For example, a pupil tracking device may perform the interactive operation according to the line of sight change of a user.

Referring to FIGS. 1A and 1B, FIG. 1A shows a conventional pupil tracking system which is configured to perform the pupil tracking of a human eye 9; and FIG. 1B shows a schematic diagram of the image of human eye captured by the conventional pupil tracking system. The pupil tracking system includes a display device 81, a light source 82, an image sensor 83 and a processing unit 84. The light source 82 is configured to emit light toward the human eye 9 so as to form a light image I₈₂ in the human eye 9 as shown in FIG. 1B. The image sensor 83 is configured to capture an image of human eye containing a pupil 91 and the light image I₈₂, and the processing unit 84 is configured to calculate the variation of a relative distance D between the pupil 91 and the light image I₈₂ in the image of human eye so as to track the pupil 91 and to accordingly control the motion of a cursor 811 shown on the display device 81. However, if there is another ambient light (not shown) forming an ambient light image I₀ in the image of human eye, errors can occur in pupil tracking.

Accordingly, the present disclosure further provides a pupil detection device capable of eliminating the interference from ambient light sources by calculating differential images thereby improving the accuracy of the pupil tracking.

### SUMMARY

The present disclosure provides a pupil detection device having a higher positioning accuracy.

The present disclosure provides a pupil detection device including a single light emitting diode, an image sensor and a digital signal processor. The single light emitting diode is configured to emit light toward an eyeball alternatively in a first brightness value and a second brightness value which is different from the first brightness value. The image sensor is configured to capture a first image frame and a second image frame respectively corresponding to the first brightness value and the second brightness value of the light emitted by the same single light emitting diode. The digital signal processor is electrically coupled to the image sensor and configured to receive the first and second image frames from the image sensor, calculate a differential image of the first and second image frames to generate an image to be identified, calculate a minimum gray value in the image to be identified before a pupil area is identified, and identify a plurality of pixels (i) surrounding the calculated minimum gray value and (ii) having gray values within a gray value range as the pupil area, wherein the calculated minimum gray value is inside a boundary of the identified pupil area.

The present disclosure further provides a pupil detection device including a single light emitting diode, two image sensors and a digital signal processor. The single light emitting diode is configured to emit light to illuminate a left eye or a right eye alternatively in a first brightness value and a second brightness value which is different from the first brightness value. Each of the two image sensors is configured to capture a first image frame and a second image frame respectively corresponding to the first brightness value and the second brightness value of the light emitted by the same single light emitting diode. The digital signal processor is electrically coupled to the two image sensors and configured to receive the first and second image frames from the two image sensors, calculate a differential image of the first and second image frames to generate a first image to be identified corresponding to one of the two image sensors and generate a second image to be identified corresponding to the other one of the two image sensors, respectively calculate a minimum gray value in each of the first image to be identified and the second image to be identified before a pupil area is identified, and identify a plurality of pixels (i) surrounding the calculated minimum gray value and (ii) having gray values within a gray value range as the pupil area, wherein the calculated minimum gray value is inside a boundary of the identified pupil area.

The present disclosure further provides a pupil detection device including a first light emitting diode, a second light emitting diode, a first image sensor, a second image sensor and a digital signal processor. The first light emitting diode is configured to emit light to illuminate a left eye. The second light emitting diode configured to emit light to illuminate a right eye. Both the first and second light emitting diodes alternatively emit the light in a first brightness value and a second brightness value which is different from the first brightness value. The first image sensor is configured to capture a first image frame and a second image frame of the left eye respectively corresponding to the first brightness value and the second brightness value of the light emitted by the first light emitting diode. The second image sensor is configured to capture a first image frame and a second image frame of the right eye respectively corresponding to the first brightness value and the second brightness value emitted by the second light emitting diode. The digital signal processor electrically is coupled to the first and second image sensors and configured to receive the first and second image frames from the first and second image sensors, calculate a differential image of the first and second image frames to generate a first image to be identified corresponding to the first image sensor and generate a second image to be identified corresponding to the second image sensor, respectively calculate a minimum gray value in each of the first image to be identified and the second image to be identified before a pupil area is identified, and identify a plurality of pixels (i) surrounding the calculated minimum gray value and (ii) having gray values within a gray value range as the pupil area, wherein the calculated minimum gray value is inside a boundary of the identified pupil area.

In one aspect, the pupil detection device may further include a display unit fur displaying images.

In one aspect, the pupil detection device may further have the function of blinking detection.

In one aspect, the pupil detection device may further have the function of doze detection and distraction detection.

In one aspect, the pupil detection device may further have the function of blinking frequency detection and dry eye detection.

In one aspect, the pupil detection device may further have the function of gesture recognition.

In the pupil detection device of the present disclosure, by identifying a plurality of pixels surrounding a minimum gray value and having gray values within a gray value range as a pupil area, it is able to eliminate the interference from ambient light sources and to improve the positioning accuracy.

In the pupil detection device of the present disclosure, the active light sources emit light alternatively in a first brightness value and a second brightness value; the image sensor captures a first image frame corresponding to the first brightness value and a second image frame corresponding to the second brightness value; and the processing unit is further configured to calculate a differential image of the first image frame and the second image frame to be served as the image to be identified. In this manner, the interference from ambient light sources may be eliminated by calculating the differential image and the positioning accuracy is improved.

### BRIEF DESCRIPTION OF THE DRAWINGS

Other objects, advantages, and novel features of the present disclosure will become more apparent from the following detailed description when taken in conjunction with the accompanying drawings.

FIG. 1A shows a schematic diagram of the conventional pupil tracking system.

FIG. 1B shows a schematic diagram of the image of human eye captured by the conventional pupil tracking system.

FIG. 2 shows an operational schematic diagram of the pupil detection device according to an embodiment of the present disclosure.

FIGS. 3A-3C show schematic diagrams of the image capturing and the lighting of the light source in the pupil detection device according to the embodiment of the present disclosure.

FIG. 4 shows a schematic diagram of performing the pupil detection according to an image to be identified captured by the pupil detection device according to the embodiment of the present disclosure.

FIG. 5A shows an operational schematic diagram of the pupil detection device according to another embodiment of the present disclosure.

FIG. 5B shows an operational schematic diagram of the pupil detection device according to an alternative embodiment of the present disclosure.

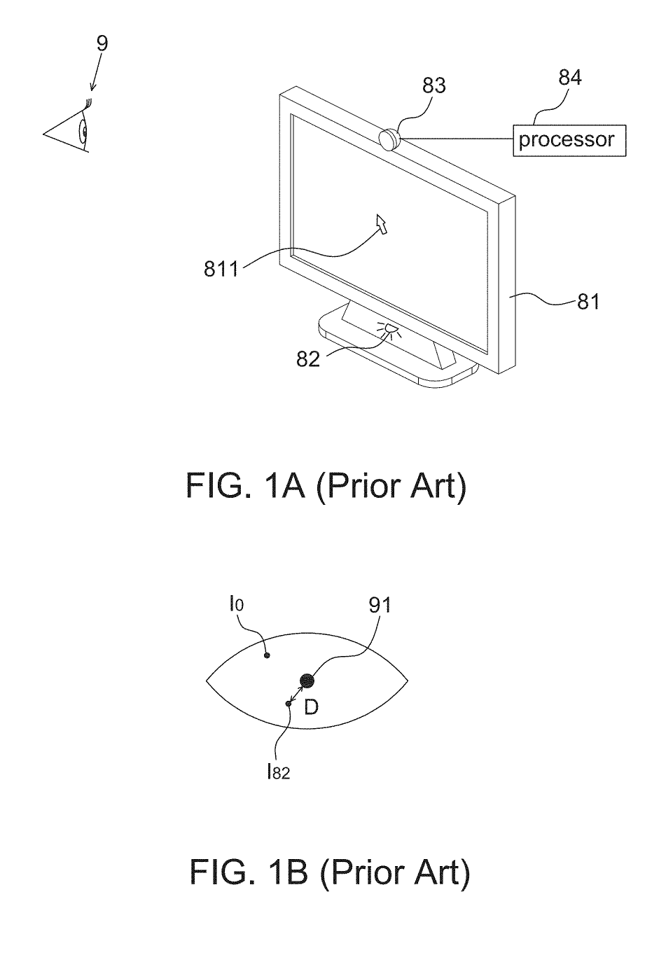

### DETAILED DESCRIPTION OF THE EMBODIMENT

It should be noted that, wherever possible, the same reference numbers will be used throughout the drawings to refer to the same or like parts.

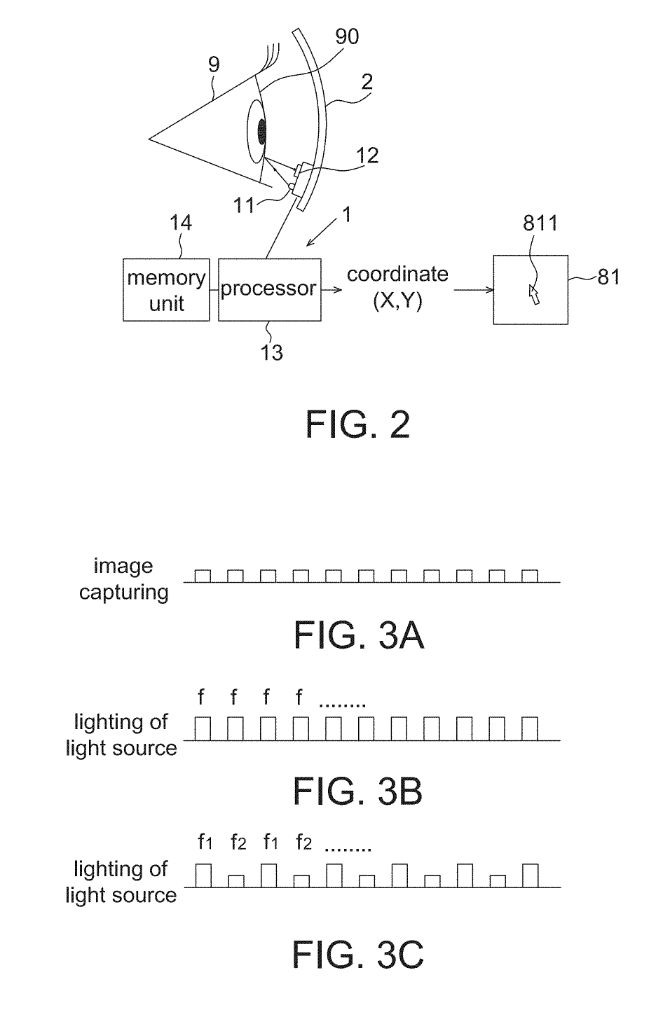

Referring to FIG. 2, it shows an operational schematic diagram of the pupil detection device 1 according to an embodiment of the present disclosure. The pupil detection device 1 is configured to detect a pupil position of an eyeball 90 and to output a pupil coordinate associated with the pupil position. The pupil detection device 1 includes an active light source 11, an image sensor 12 and a processing unit 13. Generally speaking, when the eyeball 90 looks downward the eyelid may cover a part of the eyeball 90. Therefore, if the pupil detection device 1 is disposed on a head accessory 2, a disposed position of the image sensor 12 is preferably lower than the eyeball 90. For example in FIG. 2, when the pupil detection device 1 is disposed on eyeglasses or a goggle, the pupil detection device 1 is preferably disposed at the lower frame thereof such that the pupil can be detected even though the eyeball 90 looks downward (i.e. the pupil directing downward).

The active light source 11 may be an infrared light source, e.g. an infrared light emitting diode, in order not to influence the line of sight when lighting. The active light source 11 emits light toward the eyeball 90. It should be mentioned that the active light source 11 may be a single light source or formed by arranging a plurality of light sources.

The image sensor 12 may be a photosensor configured to sense optical energy, such as a CCD image sensor, a CMOS image sensor or the like. The image sensor 12 captures at least one image frame of the eyeball 90 with a resolution and the captured image frame is served as an image to be identified.

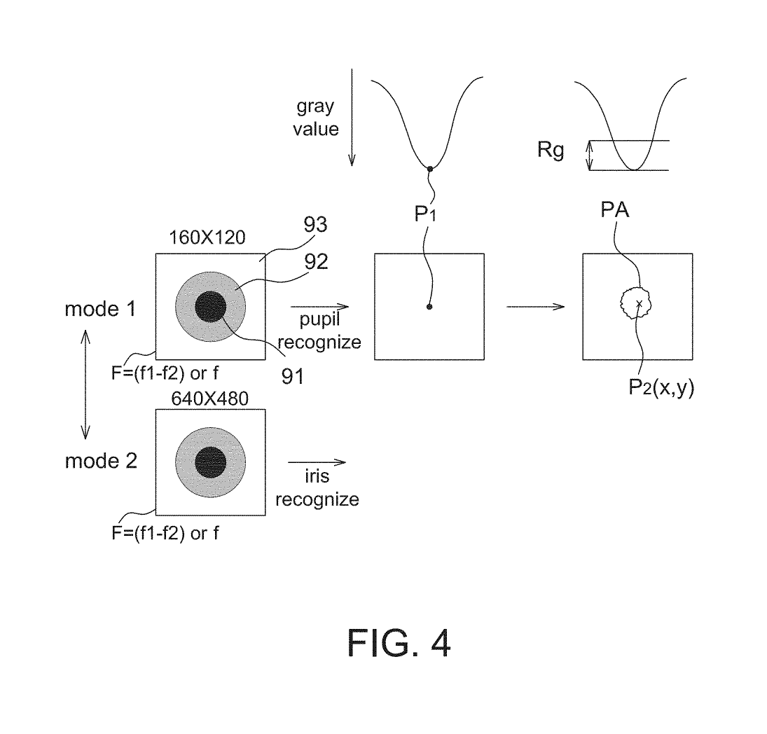

For example referring to FIGS. 3A-3C and 4, FIGS. 3A-3C show schematic diagrams of the image capturing of the image sensor 12 and the lighting of the active light source 11; and FIG. 4 shows a schematic diagram of performing the pupil detection according to the image to be identified captured by the image sensor 12. The image sensor 12 captures image frames of the eyeball 90 at a frame rate to be served as images to be identified F. In one embodiment, the active light source 11 emits light with a fixed brightness value and corresponding to the image capturing of the image sensor 12 (FIG. 3B), and the image sensor 12 sequentially outputs image frames f to be served as the image to be identified F (i.e. F=f), wherein the image to be identified F may include a pupil 91, an iris 92 and the white of the eye 93. In another embodiment, the active light source 11 emits light alternatively in a first brightness value and a second brightness value, and the image sensor 12 captures a first image frame f1 corresponding to the first brightness value and a second image frame f2 corresponding to the second brightness value (FIG. 3C). The processing unit 13 calculates a differential image (f1−f2) of the first image frame f1 and the second image frame f2 to be served as the image to be identified F; i.e. F=(f1−f2). It should be mentioned that the first brightness value may not be equal to the second brightness value and both brightness values are not equal to zero. Accordingly, the processing unit 13 may eliminate the influence from ambient light sources by calculating the differential image (f1−f2).

The processing unit 13 may be a digital signal processor (DSP), and is configured to calculate a minimum gray value P₁ in the image to be identified. F and to identify a plurality of pixels surrounding the minimum gray value P₁ and having gray values within a gray value range Rg as a pupil area PA, as shown in FIG. 4. When the active light source 11 turns on, as the pupil 91 has a lowest brightness value, the white of the eye 93 has a highest brightness value and the iris 92 has a brightness value between that of the pupil 91 and the white of the eye 93, the minimum gray value P₁ will appear inside the pupil 91. Therefore, a pixel area surrounding the minimum gray value P₁ may be identified as the pupil area PA, and the pixel area neighboring the minimum gray value P₁ may be correlated as a single object using the image grouping technique, which may be referred to U.S. Patent Publication No. 2011/0176733, entitled “image recognition method” and assigned to the same assignee as this application. In addition, the setting of the gray value range Rg may be adjusted according to the operation environment of the pupil detection device 1, e.g. different gray value ranges Rg may be set for indoors and outdoors. Furthermore, in order to eliminate the noise interference, the processing unit 13 may further identify whether the pupil area PA is an image of ambient light source according to its features such as the size and shape thereof. For example, if the pupil area PA is too small or not an approximate circle, it may be an image of ambient light source and can be removed.

Next, the processing unit 13 may calculate a gravity center or a center of the pupil area PA to be served as a pupil position P₂ and output a pupil coordinate (x,y) associated with the pupil position P₂. The processing unit 13 may relatively control the motion of a cursor 811 shown on a display device 81 according to the pupil coordinate (x,y). It is appreciated that the pupil position P₂ may not be the same as a position of the minimum gray value P₁.

In addition, as the pupil detection device 1 may be configured to control an electronic device, in some cases the pupil detection device 1 may preferably recognize the user ID so as to increase the practicability or realize the privacy protection. Therefore, the processing unit 13 may perform the iris recognition according to the image to be identified F. In this case the pupil detection device 1 may further include a memory unit 14 configured to save the iris information of different users. In addition, as the iris recognition needs a higher image resolution and the pupil area identification needs a lower image resolution, in this embodiment a resolution and a frame rate of the image sensor 12 may be adjustable. For example, when the processing unit 13 is configured to perform the iris recognition (e.g. a second mode), the image sensor 12 may capture image frames with a first resolution and a first frame rate, whereas when the processing unit 13 is configured to identify the pupil area (e.g. a first mode), the image sensor 12 may capture image frames with a second resolution and a second frame rate, wherein the first resolution may be higher than the second resolution and the first frame rate may be lower than the second frame rate. In this embodiment, an adjustable range of the image resolution may be between 640×480 and 160×120, and an adjustable range of the frame rate may be between 30 FPS and 480 FPS (frame/second), but the present disclosure is not limited thereto.

In this embodiment, as the processing unit 13 performs the pupil detection based on the minimum gray value in the eyeball image, it is able to eliminate the interference from ambient light sources since the ambient light image has a higher gray value. In addition, it is able to further eliminate the ambient light image by calculating the differential image.

In another embodiment, the pupil detection device 1 may include more than two image sensors configured to capture image frames of the same eyeball and to accordingly calculate a three-dimensional pupil position and cover a larger detection range; i.e. the two image sensors configured to capture image frames of the same eyeball may be separated by a predetermined distance.

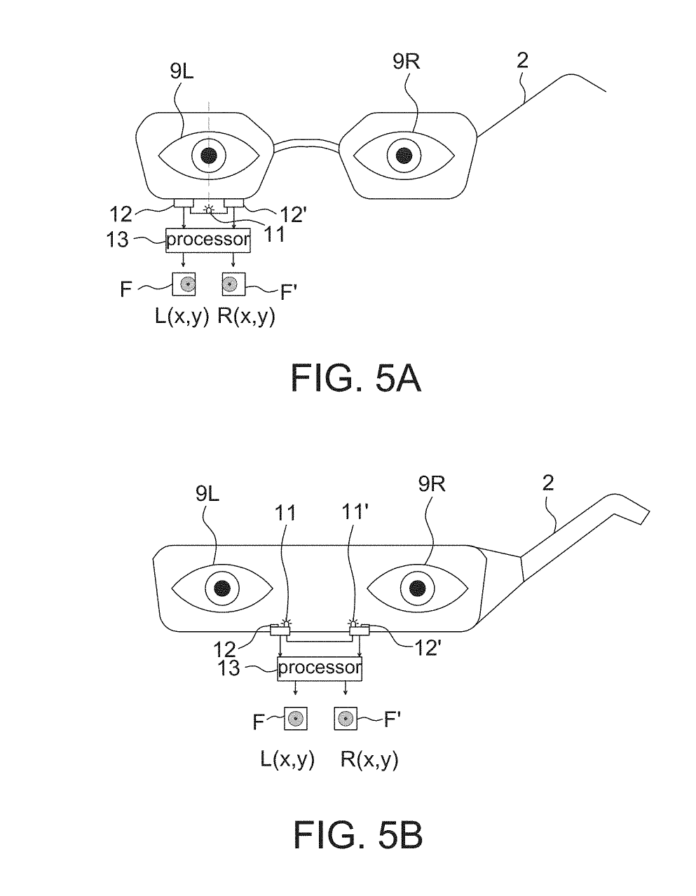

Referring to FIG. 5A, it shows a schematic diagram of the pupil detection device 1 according to another embodiment of the present disclosure. Although the pupil detection device 1 is shown to be disposed on eyeglasses, the present disclosure is not limited thereto. The pupil detection device 1 includes at least one active light source 11, two image sensors 12, 12′ and a processing unit 13. It should be mentioned that in this embodiment a plurality of active light sources 11 may be used to improve the illumination (e.g. the active light source 11 may be formed by arranging a plurality of light sources); and a number of the image sensors 12, 12′ is not limited to two. If three, four or more image sensors are included, each of the image sensors operates similar to the image sensors 12, 12′ and only their disposed positions are different. However, their disposed positions are also preferably lower than the human eye 9. In addition, although the pupil detection device 1 is shown to be arranged corresponding to the left eye 9L, it may also be arranged corresponding to the right eye 9R. That is, if the pupil detection device 1 is disposed on a head accessory 2, the two image sensors 12, 12′ are preferably disposed lower than the left eye 9L or the right eye 9R.

The at least one active light source 11 emits light to illuminate a left eye 9L or a right eye 9R. The two image sensors 12, 12′ capture, with a resolution, at least one image frame of the left eye 9L or the right eye 9R which is illuminated by the at least one active light source 11 to be served as a first image to be identified F and a second image to be identified F′, wherein the two image sensors 12, 12′ may or may not capture the image frames simultaneously. The processing unit 13 is configured to respectively calculate a minimum gray value P₁ in the first image to be identified F and the second image to be identified F′, and to identify a plurality of pixels surrounding the minimum pixel value P₁ and having gray values within a gray value range Rg as a pupil area PA. After the pupil area PA is obtained, the processing unit 13 is further configured to calculate a gravity center or a center of the pupil area PA to be served as a pupil position P2 as shown in FIG. 4 and to output a left pupil coordinate L(x,y) and a right pupil coordinate R(x,y). In this embodiment, as the pupil is detected by using two images to be identified F, F′, the processing unit 13 may calculate a three-dimensional pupil position according to the pupil position P2 in the first image to be identified F and the second image to be identified F′. For example, the two image sensors 12, 12′ may be respectively disposed at two sides of a center line of the human eye 9, and the processing unit 13 may calculate the three-dimensional pupil position according to the two images to be identified F, ′F.

As mentioned above, in order to eliminate the ambient light image, the processing unit 13 may respectively calculate a differential image at first and then identify the pupil area PA according to the differential image. In this case the at least one active light source 11 emits light alternatively in a first brightness value and a second brightness value; the two image sensors 12, 12′ capture a first image frame f1 corresponding to the first brightness value and a second image frame f2 corresponding to the second brightness value (as shown in FIG. 3C); and the processing unit 13 may calculate a differential image (f1−f2) of the first image frame f1 and the second image frame f2 to be served as the first image to be identified F and the second image to be identified F′.

Similarly, in this embodiment the processing unit 13 may perform the iris recognition according to the first image to be identified F and/or the second image to be identified F′. When the processing unit 13 is configured to perform the iris recognition, the image sensor 12 captures image frames with a first resolution and a first frame rate, whereas when the processing unit 13 is configured to identify the pupil area, the image sensor 12 captures image frames with a second resolution and a second frame rate, wherein the first resolution may be higher than the second resolution, whereas the first frame rate may be lower than the second frame rate.

In another embodiment, the pupil detection device 1 may include more than two image sensors configured to respectively capture image frames of different eyes so as to output the detection result of the left eye and/or the right eye according to different conditions.

Referring to FIG. 5B, it shows a schematic diagram of the pupil detection device 1 according to an alternative embodiment of the present disclosure. Although the pupil detection device 1 is shown to be disposed on a goggle, but the present disclosure is not limited thereto. The pupil detection device 1 includes two active light sources 11, 11′, two image sensors 12, 12′ and a processing unit 13. It should be mentioned that more than one active light source may be used corresponding to each human eye so as to improve the illumination; and a plurality of image sensors may be used corresponding to each human eye (as shown in FIG. 5A). Similarly, if the pupil detection device 1 is disposed on a head accessory 2, disposed positions of the two image sensors 12, 12′ are preferably lower than the left eye 9L and the right eye 9R.

The two active light sources 11, 11′ emit light to respectively illuminate a left eye 9L and a right eye 9R. The two image sensors 12, 12′ respectively capture, with a resolution, at least one image frame of the left eye 9L and the right eye 9R to be served as a first image to be identified F and a second image to be identified F′. The processing unit 13 is configured to respectively calculate a minimum gray value P₁ in the first image to be identified F and the second image to be identified F′, and to identify a plurality of pixels surrounding the minimum gray value P₁ and having gray values within a gray value range Rg as a pupil area PA. After the pupil area PA is obtained, the processing unit 13 may calculate a gravity center or a center of the pupil area PA to be served as a pupil position P2 (as shown in FIG. 4) and output a left pupil coordinate L(x,y) and a right pupil coordinate R(x,y). As two pupils are respectively detected using different images to be identified in this embodiment, coordinates of the two pupils may be respectively calculated and different pupil coordinates may be outputted according to different conditions. For example when the human eye looks rightward, the left eye 9L may be blocked by the nose bridge and not be able to see the object at the right hand side, the processing unit 13 may only calculate a right pupil coordinate R(x,y) associated with the right eye 9R according to the pupil position. For example when the human eye looks leftward, the right eye 9R may be blocked by the nose bridge and not be able to see the object at the left hand side, the processing unit 13 may only calculate a left pupil coordinate L(x,y) associated with the left eye 9L according to the pupil position. In other conditions the processing unit 13 may calculate an average pupil coordinate associated with the left eye 9L and the right eye 9R according to the pupil position. The present disclosure is not limited to the conditions above.

In another embodiment, it is able to estimate a gaze direction or a gaze distance according to the relationship between the left pupil coordinate L(x,y) and the right pupil coordinate R(x,y).

In another embodiment, if more than two image sensors are respectively arranged corresponding to the left eye 9L and the right eye 9R, three-dimensional pupil positions of the left eye 9L and the right eye 9R may be respectively obtained.

As mentioned above, in order eliminate the ambient light image, the processing unit 13 may respectively calculate a differential image at first and then identify the pupil area PA according to the differential image. In this case the two active light sources 11 emit light alternatively in a first brightness value and a second brightness value; the two image sensors 12, 12′ capture a first image frame f1 corresponding to the first brightness value and a second image frame f2 corresponding to the second brightness value (as shown in FIG. 3C); and the processing unit 13 may calculate a differential image (f1−f2) of the first image frame f1 and the second image frame f2 to be served as the first image to be identified F and the second image to be identified F′.

Similarly, in this embodiment the processing unit 13 may perform the iris recognition according to the first image to be identified F and/or the second image to be identified F′. When the processing unit 13 is configured to perform the iris recognition, the image sensors 12, 12′ may capture image frames with a first resolution and a first frame rate, whereas when the processing unit 13 is configured to identify the pupil area, the image sensors 12, 12′ may capture image frames with a second resolution and a second frame rate, wherein the first resolution may be higher than the second resolution, whereas the first frame rate may be lower than the second frame rate.

In addition, the pupil detection device 1 of each embodiment of the present disclosure may cooperate with a display unit for displaying images, and the display unit may also be disposed on the head accessory 2, such as eyeglasses or a goggle.

The pupil detection device 1 of each embodiment of the present disclosure may further have the function of blinking detection. For example, the processing unit 13 may record time intervals during which the pupil is detected and is not detected so as to identify the blinking operation.

The pupil detection device 1 of each embodiment of the present disclosure may further have the function of doze detection and distraction detection. For example, when the pupil detection device 1 is applied to a vehicle device, it is able to detect whether the driver is sleepy or pays attention to a forward direction and to give a warning at a proper time. The doze detection may be implemented by detecting a time ratio between eye open and eye close. The distraction detection may be implemented by detecting a gaze direction of the driver.

The pupil detection device 1 of each embodiment of the present disclosure may further have the function of blinking frequency detection and dry eye detection. Specifically speaking, the processing unit 13 may estimate the possibility and degree of the dry eye according to the detected blinking frequency and then remind the user to blink his or her eyes.

The pupil detection device 1 of each embodiment of the present disclosure may further have the function of gesture recognition. The gesture recognition may be performed by moving the pupil toward a predetermined direction for a predetermined times and comparing the pupil movement with a predetermined gesture so as to execute specific functions. The gesture recognition is similar to those performed by other objects rather than the pupil, such as the gesture recognition performed by a hand motion or a finger motion.

The pupil detection device 1 of each embodiment of the present disclosure may further have the function of power saving. For example, the power save mode may be entered if the pupil is not detected for a predetermined time interval or the image variation of the image to be identified is too small.

It should be mentioned that the pupil detection device 1 of each embodiment of the present disclosure may be directly manufactured as a head pupil detection device or be attached to a head accessory, e.g. eyeglasses, a goggle or a hat edge via a combining element. In other embodiments, the pupil detection device 1 of each embodiment of the present disclosure may be disposed at other positions for performing the pupil detection, e.g. disposed in a car and close to the user's eyes (e.g. on a rearview mirror) as long as it is disposed at a position capable of detecting the human eye 9.

As mentioned above, the conventional pupil detection device is not able to eliminate the interference from ambient light sources and thus errors can occur in detection. Therefore, the present disclosure further provides a pupil detection device (FIGS. 2, 5A and 5B) that may eliminate the interference from ambient light sources thereby having a higher detection accuracy.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A pupil detection device, comprising:
a single light emitting diode configured to emit light toward an eyeball alternatively in a first brightness value and a second brightness value which is different from the first brightness value;
an image sensor configured to capture a first image frame and a second image frame respectively corresponding to the first brightness value and the second brightness value of the light emitted by the same single light emitting diode; and
a digital signal processor electrically coupled to the image sensor and configured to
receive the first and second image frames from the image sensor,
calculate a differential image of the first and second image frames to generate a image to be identified,
calculate a minimum gray value in the image to be identified before a pupil area is identified, and
identify a plurality of pixels (i) surrounding the calculated minimum gray value and (ii) having gray values within a gray value range as the pupil area, wherein the calculated minimum gray value is inside a boundary of the identified pupil area.

2. The pupil detection device as claimed in claim 1, wherein the pupil detection device is disposed on an inner side of eyeglasses or a goggle.

3. The pupil detection device as claimed in claim 1, wherein the plurality of pixels determines the boundary of the identified pupil area.

4. The pupil detection device as claimed in claim 1, wherein the calculated minimum gray value is not configured to determine the boundary of the identified pupil area.

5. A pupil detection device, comprising:
a single light emitting diode configured to emit light to illuminate a left eye or a right eye alternatively in a first brightness value and a second brightness value which is different from the first brightness value;
two image sensors each configured to capture a first image frame and a second image frame respectively corresponding to the first brightness value and the second brightness value of the light emitted by the same single light emitting diode; and
a digital signal processor electrically coupled to the two image sensors and configured to
receive the first and second image frames from the two image sensors,
calculate a differential image of the first and second image frames to generate a first image to be identified corresponding to one of the two image sensors and generate a second image to be identified corresponding to the other one of the two image sensors,
respectively calculate a minimum gray value in each of the first image to be identified and the second image to be identified before a pupil area is identified, and
identify a plurality of pixels (i) surrounding the calculated minimum gray value and (ii) having gray values within a gray value range as the pupil area, wherein the calculated minimum gray value is inside a boundary of the identified pupil area.

6. The pupil detection device as claimed in claim 5, wherein the pupil detection device is disposed on an inner side of eyeglasses or a goggle.

7. The pupil detection device as claimed in claim 5, wherein the plurality of pixels determines the boundary of the identified pupil area.

8. The pupil detection device as claimed in claim 5, wherein the calculated minimum gray value is not configured to determine the boundary of the identified pupil area.

9. A pupil detection device, comprising:
a first light emitting diode configured to emit light to illuminate a left eye and a second light emitting diode configured to emit light to illuminate a right eye, both the first and second light emitting diodes alternatively emitting the light in a first brightness value and a second brightness value which is different from the first brightness value;
a first image sensor configured to capture a first image frame and a second image frame of the left eye respectively corresponding to the first brightness value and the second brightness value of the light emitted by the first light emitting diode,
a second image sensor configured to capture a first image frame and a second image frame of the right eye respectively corresponding to the first brightness value and the second brightness value emitted by the second light emitting diode; and
a digital signal processor electrically coupled to the first and second image sensors and configured to
receive the first and second image frames from the first and second image sensors,
calculate a differential image of the first and second image frames to generate a first image to be identified corresponding to the first image sensor and generate a second image to be identified corresponding to the second image sensor,
respectively calculate a minimum gray value in each of the first image to be identified and the second image to be identified before a pupil area is identified, and
identify a plurality of pixels (i) surrounding the calculated minimum gray value and (ii) having gray values within a gray value range as the pupil area, wherein the calculated minimum gray value is inside a boundary of the identified pupil area.

10. The pupil detection device as claimed in claim 9, wherein the pupil detection device is disposed on an inner side of eyeglasses or a goggle.
